(19) United States
(12) Patent Application Publication
(10) Pub. No.: US 2026/0040016 A1
(43) Pub. Date: Feb. 5, 2026

(54) AUDIO SYSTEM, AUDIO DEVICE, PROGRAM, AND AUDIO PLAYBACK METHOD

(71) Applicant: D&M Holdings Inc., Kanagawa (JP)

(72) Inventor: Hanako Chuto, Kanagawa (JP)

(21) Appl. No.: 19/100,299

(22) PCT Filed: Mar. 29, 2023
(86) PCT No.: PCT/JP2023/012824

§ 371 Date: Jan. 31, 2025

(30) Foreign Application Priority Data
Aug. 11, 2022 (JP) 2022-128564

(51) Int. Cl. H04S 3/00; G10K 11/178

(52) U.S. Cl. CPC H04S 3/008; G10K 11/17823; G10K 11/17873; G10K 2210/3011; G10K 2210/3027; G10K 2210/3028; H04S 2400/01

(57) ABSTRACT

[Problem] To provide a technology capable of suppressing sound leakage to the outside of a room even when a user listens to audio in the room at a preferred sound volume. [Solution] This multi-channel audio device 1 performs sound output on audio playback signals from channels through respective playback speakers 2, and performs sound output on antiphase signals of the audio playback signals through an antiphase speaker 3. The attenuation rates and the delay times of the audio playback signals output from the respective playback speakers 2 at the installation position of the antiphase speaker 3 are stored in advance, and during the audio playback, the antiphase signals of the audio playback signals of the respective channels are attenuated on the basis of the respective attenuation rates, are delayed on the basis of the respective delay times, and are output as sound from the antiphase speaker 3.

### TECHNICAL FIELD

The present invention relates to an audio reproduction technology, and more particularly, to a technology for suppressing sound leakage of an audio reproduction signal.

### BACKGROUND ART

There is known a multi-channel audio device that reproduces multi-channel audio content with use of a plurality of speakers. For example, a multi-channel audio device as described in Patent Literature 1 reproduces and amplifies an audio reproduction signal for each channel of multi-channel audio content, and outputs the audio reproduction signal from a speaker corresponding to this channel.

In addition, some multi-channel audio devices enable acoustic profile information (including an output timing and a volume level) on an audio reproduction signal to be set for each channel of the multi-channel audio content. For example, a multi-channel audio device as described in Patent Literature 2 picks up, for each channel of multi-channel audio content, a sound of a test signal output from a speaker corresponding to this channel by a dedicated measurement microphone installed at a listening point, and measures a delay time and an attenuation rate of the sound. Then, the acoustic profile information is set for each channel of the multi-channel audio content so that acoustic characteristics of the audio reproduction signal output from the speaker corresponding to this channel are optimum at the listening point.

### CITATION LIST

### Patent Literature

[PTL 1] JP 2002-367290 A

[PTL 2] JP 2000-354300 A

### SUMMARY OF INVENTION

### Technical Problem

With the multi-channel audio devices of the related art as described in Patent Literature 1 and Patent Literature 2, a user can enjoy realistic-feeling sounds owing to the audio reproduction signals of the respective channels which are output from a plurality of speakers. According to the multi-channel audio device as described in Patent Literature 2, in particular, a sound optimum for the listening point can be enjoyed.

However, when the user listens to audio in a room at a volume level preferred by the user, there is a possibility that a sound leaks outside the room to offend a person outside the room.

The present invention has been made in view of the above-mentioned circumstance, and an object thereof is to provide a technology that enables suppression of sound leakage outside a room when a user listens to audio in the room at a volume level preferred by the user.

### Solution to Problem

In order to attain the above-mentioned object, in the present invention, audio output of an audio reproduction signal from a reproduction speaker is executed and, at the same time, audio output of an opposite-phase signal of this audio reproduction signal is executed from an opposite-phase speaker. An attenuation rate and a delay time of the audio reproduction signal output in the form of audio from the reproduction speaker that are observed at an installation position of the opposite-phase speaker are stored in advance. Then, at a time of audio output of the audio reproduction signal from the reproduction speaker, audio output of the opposite-phase signal of this audio reproduction signal is executed from the opposite-phase speaker with the opposite-phase signal attenuated based on the attenuation rate stored in advance and delayed based on the delay time stored in advance.

For example, an audio system according to one embodiment of the present invention is an audio system including: an audio device configured to output an audio reproduction signal; and a reproduction speaker configured to output, in the form of audio, the audio reproduction signal output from the audio device. The audio system further includes an opposite-phase speaker. The audio device includes: opposite-phase signal generation means for generating an opposite-phase signal of the audio reproduction signal; installation position information storage means for storing an attenuation rate and a delay time of the audio reproduction signal output in the form of audio from the reproduction speaker that are observed at an installation the opposite-phase speaker; and opposite-phase signal output means for outputting the opposite-phase signal generated by the opposite-phase signal generation means to the opposite-phase speaker, with the opposite-phase signal attenuated based on the attenuation rate stored in the installation position information storage means, and delayed based on the delay time stored in the installation position information storage means. The opposite-phase speaker is configured to output, in the form of audio, the opposite-phase signal output from the audio device.

Further, for example, an audio device according to one embodiment of the present invention is an audio device for outputting an audio reproduction signal to a reproduction speaker. The audio device includes: opposite-phase signal generation means for generating an opposite-phase signal of the audio reproduction signal; installation position information storage means for storing an attenuation rate and a delay time of the audio reproduction signal output in the form of audio from the reproduction speaker that are observed at an installation position of an opposite-phase speaker provided separately from the reproduction speaker; and opposite-phase signal output means for outputting the opposite-phase signal generated by the opposite-phase signal generation means to the opposite-phase speaker, with the opposite-phase signal attenuated based on the attenuation rate stored in the installation position information storage means, and delayed based on the delay time stored in the installation position information storage means.

### Advantageous Effects of Invention

In the present invention, the attenuation rate and the delay time of the audio reproduction signal output in the form of audio from the reproduction speaker that are observed at the installation position of the opposite-phase speaker are stored in advance. Then, at the time of audio output of the audio reproduction signal from the reproduction speaker, audio output of the opposite-phase signal of this audio reproduction signal is executed from the opposite-phase speaker with the opposite-phase signal attenuated based on the attenuation rate stored in advance and delayed based on the delay time stored in advance. Accordingly, the audio reproduction signal that is output in the form of audio from the reproduction speaker can be canceled out at the installation position of the opposite-phase speaker with the opposite-phase signal.

According to the present invention, even when the user listens to audio in a room at a volume level preferred by the user, sound leakage outside the room can thus be suppressed by installing the opposite-phase speaker at a location at which sound leakage to the outside is suspected to occur.

### BRIEF DESCRIPTION OF DRAWINGS

FIG. 1 is a schematic configuration diagram of a multi-channel audio system according to one embodiment of the present invention.

FIG. 2 is a sequence diagram for illustrating installation position information setting operation of the multi-channel audio system.

FIG. 3 is a sequence diagram for illustrating the installation position information setting operation of the multi-channel audio system, and is a continuation of FIG. 2.

FIG. 4 is a schematic functional configuration diagram of a multi-channel audio device (1).

FIG. 5 is a flow chart for illustrating installation position information setting processing of the multi-channel audio device (1).

FIG. 6 is a diagram for illustrating a flow of signals in audio reproduction processing of the multi-channel audio device (1), and utilizes a part of the functional configuration diagram illustrated in FIG. 4.

FIG. 7 is a schematic functional configuration diagram of a wireless terminal (4).

FIG. 8 is a flow chart for illustrating installation position information setting processing of the wireless terminal (4).

### DESCRIPTION OF EMBODIMENTS

Now, one embodiment of the present invention is described with reference to the drawings.

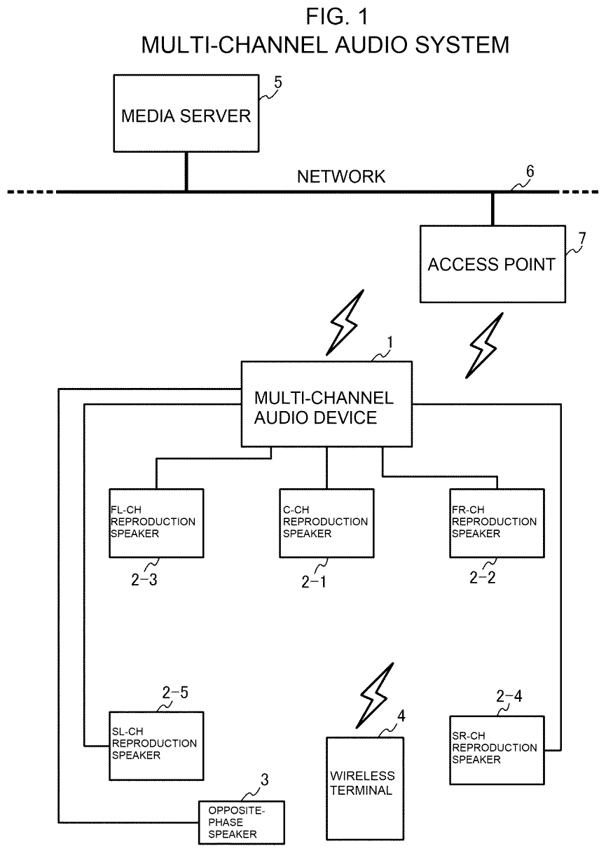

FIG. 1 is a schematic configuration diagram of a multi-channel audio system according to this embodiment.

As illustrated, the multi-channel audio system according to this embodiment includes a multi-channel audio device 1 which is connected to a media server 5 via an access point 7 and a network 6 such as a wide area network (WAN) or a local area network (LAN), reproduction speakers 2-1 to 2-5 (in the following, may simply be referred to as “reproduction speakers 2”) each of which is provided for one of channels, an opposite-phase speaker 3, and a wireless terminal 4 connected by wireless connection to the multi-channel audio device 1 via the access point 7.

The multi-channel audio device 1 downloads multi-channel audio content from the media server 5, reproduces the downloaded multi-channel audio content in the form of an audio reproduction signal for each of the channels, and outputs the audio reproduction signals from the speakers 2-1 to 2-5.

In this embodiment, a case of reproducing multi-channel audio content of 5 channels is illustrated as an example, and the five reproduction speakers 2-1 to 2-5 corresponding to a center (C) channel, a front right (FR) channel, a front left (FL) channel, a surround right (SR) channel, and a surround left (SL) channel are connected to the multi-channel audio device 1.

The opposite-phase speaker 3 is installed at a location that has a possibility of sound leakage outside a room in which the multi-channel audio system is installed, such as the vicinity of a wall surface, a window, or a door of the room.

The multi-channel audio device 1 generates an opposite-phase signal of an audio reproduction signal for each channel of the multi-channel audio content. The multi-channel audio device 1 then adjusts an output volume level and output timing of the opposite-phase signal for each channel, based on an attenuation rate and a delay time (these are hereinafter referred to as “installation position information”) of the audio reproduction signal output in the form of audio from one of the reproduction speakers 2 that corresponds to the channel, at the installation position of the opposite-phase speaker 3. The adjusted opposite-phase signals are synthesized to be output in the form of audio from the opposite-phase speaker 3. In this manner, the audio reproduction signals output in the form of audio from the reproduction speakers 2 of the respective channels are canceled out in the vicinity of the installation position of the opposite-phase speaker 3, with the result that sound leakage outside the room is suppressed.

The wireless terminal 4 is a smartphone, a tablet personal computer (PC), or the like that includes a microphone or a microphone input terminal, and functions as a controller for remotely operating the multi-channel audio device 1. The wireless terminal 4 also measures, at the installation position of the opposite-phase speaker 3, for each channel of the multi-channel audio content, a volume level and arrival timing of the audio reproduction signal output in the form of audio from one of the reproduction speakers 2 that corresponds to the channel, and transmits results of the measurement to the multi-channel audio device 1.

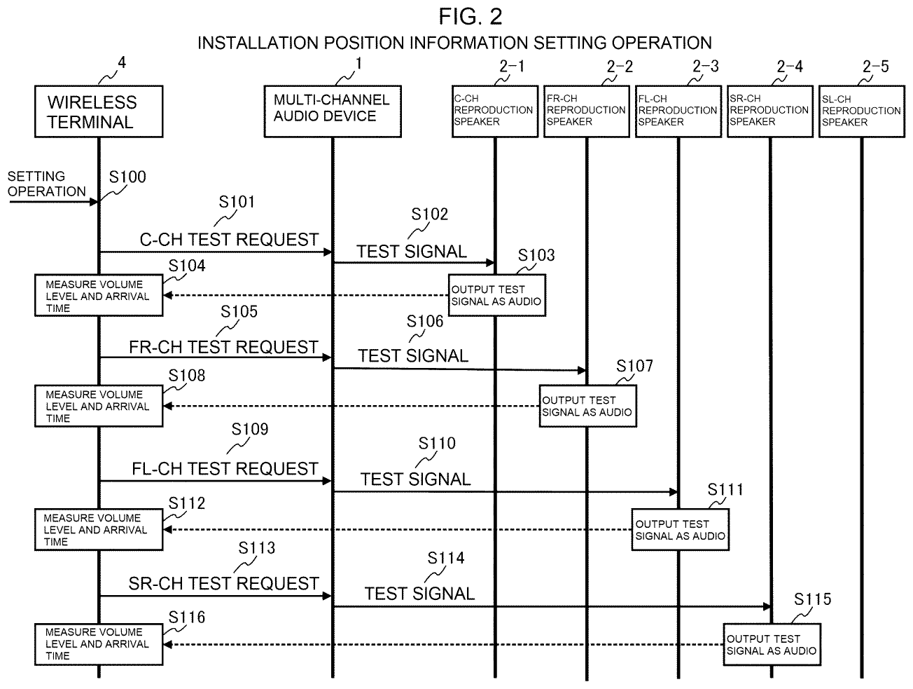

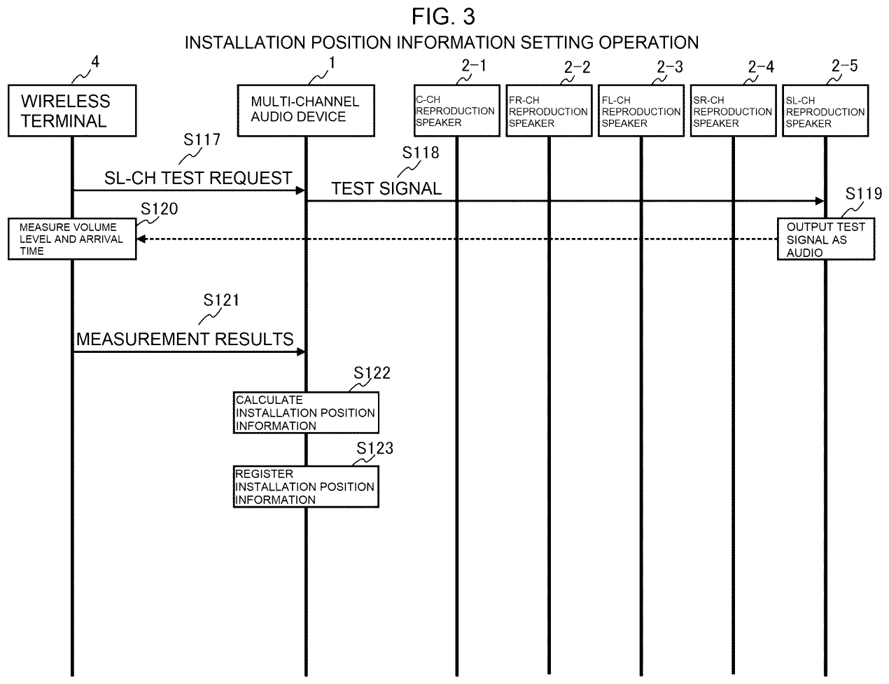

FIG. 2 and FIG. 3 are sequence diagrams for illustrating installation position information setting operation of the multi-channel audio system.

First, a user carrying the wireless terminal 4 goes to the installation position of the opposite-phase speaker 3, and performs installation position information setting operation on the wireless terminal 4 at the installation position. The wireless terminal 4 receives the installation position information setting operation from the user (Step S100), and transmits a C-channel test request to the multi-channel audio device 1 (Step S101). The multi-channel audio device 1 receives the request, transmits an audio signal for testing (hereinafter referred to as “test signal”) to the reproduction speaker 2-1 of the C channel (Step S102), and outputs the test signal in the form of audio from the reproduction speaker 2-1 of the C channel (Step S103). The wireless terminal 4 uses a built-in microphone or a microphone connected to the microphone input terminal to pick up the test signal output in the form of audio from the reproduction speaker 2-1 of the C channel, and measures the volume level and arrival timing of the test signal (Step S104).

Next, the wireless terminal 4 transmits an FR-channel test request to the multi-channel audio device 1 (Step S105). The multi-channel audio device 1 receives the request, transmits a test signal to the reproduction speaker 2-2 of the FR channel (Step S106), and outputs the test signal in the form of audio from the reproduction speaker 2-2 of the FR channel (Step S107). The wireless terminal 4 uses the built-in microphone or the microphone connected to the microphone input terminal to pick up the test signal output in the form of audio from the reproduction speaker 2-2 of the FR channel, and measures the volume level and arrival timing of the test signal (Step S108).

Next, the wireless terminal 4 transmits an FL-channel test request to the multi-channel audio device 1 (Step S109). The multi-channel audio device 1 receives the request, transmits a test signal to the reproduction speaker 2-3 of the FL channel (Step S110), and outputs the test signal in the form of audio from the reproduction speaker 2-3 of the FL channel (Step S111). The wireless terminal 4 uses the built-in microphone or the microphone connected to the microphone input terminal to pick up the test signal output in the form of audio from the reproduction speaker 2-3 of the FL channel, and measures the volume level and arrival timing of the test signal (Step S112).

Next, the wireless terminal 4 transmits an SR-channel test request to the multi-channel audio device 1 (Step S113). The multi-channel audio device 1 receives the request, transmits a test signal to the reproduction speaker 2-4 of the SR channel (Step S114), and outputs the test signal in the form of audio from the reproduction speaker 2-4 of the SR channel (Step S115). The wireless terminal 4 uses the built-in microphone or the microphone connected to the microphone input terminal to pick up the test signal output in the form of audio from the reproduction speaker 2-4 of the SR channel, and measures the volume level and arrival timing of the test signal (Step S116).

Next, the wireless terminal 4 transmits an SL-channel test request to the multi-channel audio device 1 (Step S117). The multi-channel audio device 1 receives the request, transmits a test signal to the reproduction speaker 2-5 of the SL channel (Step S118), and outputs the test signal in the form of audio from the reproduction speaker 2-5 of the SL channel (Step S119). The wireless terminal 4 uses the built-in microphone or the microphone connected to the microphone input terminal to pick up the test signal output in the form of audio from the reproduction speaker 2-5 of the SL channel, and measures the volume level and arrival timing of the test signal (Step S120).

After the measurement of the volume level and the arrival timing of the test signal is completed for each channel, the wireless terminal 4 transmits results of the measurement to the multi-channel audio device 1 as the volume levels and the arrival timing of the test signals of the respective channels at the installation position of the opposite-phase speaker 3 (Step S121). The multi-channel audio device 1 receives the results and calculates, for each channel, installation position information of one of the reproduction speakers 2 that corresponds to the channel (Step S122). Specifically, an attenuation rate of the test signal at the installation position of the opposite-phase speaker 3 is calculated for each channel based on an output volume level of the test signal output from one of the reproduction speakers 2 that corresponds to the channel, and the volume level (measurement result) of the test signal at the installation position of the opposite-phase speaker 3. A delay time of the test signal at the installation position of the opposite-phase speaker 3 is also calculated for each channel based on output timing of the test signal output from the one of the reproduction speakers 2, and the arrival timing (measurement result) of the test signal at the installation position of the opposite-phase speaker 3.

The multi-channel audio device 1 then registers, for each channel, the attenuation rate and the delay time of the test signal as the installation position information of the one of the reproduction speakers 2 that corresponds to this channel (Step S123).

In the example illustrated in FIG. 2 and FIG. 3, the measurement of the volume levels and the arrival timing of the test signals at the installation position of the opposite-phase speaker 3 is executed by issuing test requests for the C channel, the FR channel, the FL channel, the SR channel, and the SL channel in the stated order, but the order of measurement is not limited thereto. The measurement may be executed in any order among the plurality of reproduction speakers 2 as long as the volume level and the arrival timing of the test signal at the installation position of the opposite-phase speaker 3 can be measured for every channel of the multi-channel audio content.

Next, details of the multi-channel audio device 1 and the wireless terminal 4, which are included in the multi-channel audio system according to this embodiment, are described.

Existing general speakers are usable for the reproduction speakers 2 and the opposite-phase speaker 3, and detailed descriptions thereof are accordingly omitted.

First, the details of the multi-channel audio device 1 are described.

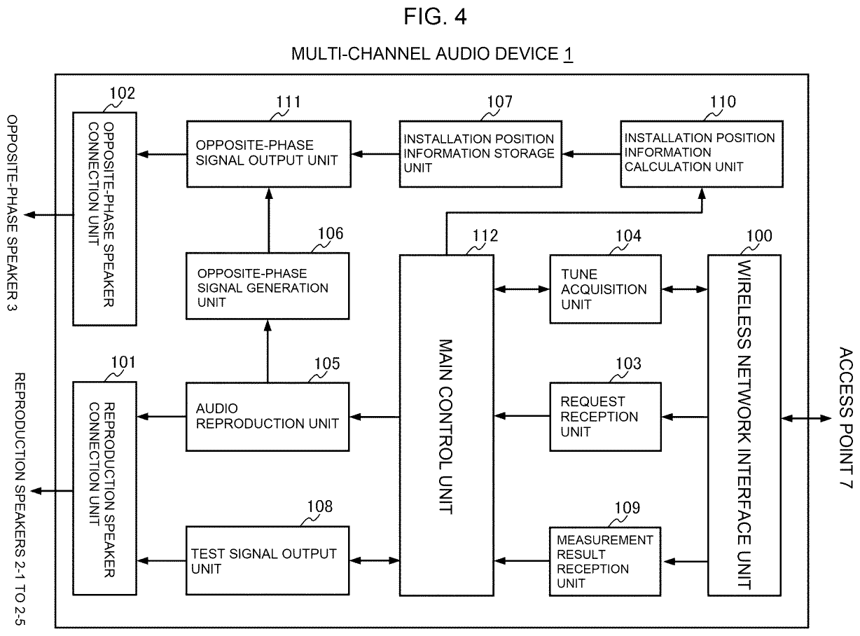

FIG. 4 is a schematic functional configuration diagram of the multi-channel audio device 1.

As illustrated, the multi-channel audio device 1 includes a wireless network interface unit 100, a reproduction speaker connection unit 101, an opposite-phase speaker connection unit 102, a request reception unit 103, a tune acquisition unit 104, an audio reproduction unit 105, an opposite-phase signal generation unit 106, an installation position information storage unit 107, a test signal output unit 108, a measurement result reception unit 109, an installation position information calculation unit 110, an opposite-phase signal output unit 111, and a main control unit 112.

The wireless network interface unit 100 is an interface for wireless connection to the access point 7.

The reproduction speaker connection unit 101

includes, although not shown, for each channel, a connection terminal for connection to one of the reproduction speakers 2 that corresponds to the channel. In this embodiment, the reproduction speaker connection unit 101 includes a C channel connection terminal for connection to the reproduction speaker 2-1 corresponding to the C channel, an FR channel connection terminal for connection to the reproduction speaker 2-2 corresponding to the FR channel, an FL channel connection terminal for connection to the reproduction speaker 2-3 corresponding to the FL channel, an SR connection terminal for connection to the reproduction speaker 2-4 corresponding to the SR channel, and an SL channel connection terminal for connection to the reproduction speaker 2-5 corresponding to the SL channel.

The opposite-phase speaker connection unit 102 includes, although not shown, a connection terminal for connection to the opposite-phase speaker 3.

The request reception unit 103 receives various requests from the wireless terminal 4 via the wireless network interface unit 100.

The tune acquisition unit 104 accesses the media server 5 via the wireless network interface unit 100 to download multi-channel audio content from the media server 5 in accordance with a tune acquisition request received by the request reception unit 103 from the wireless terminal 4.

The audio reproduction unit 105 reproduces the multi-channel audio content downloaded by the tune acquisition unit 104, in the form of audio reproduction signals of a plurality of channels (in this embodiment, the FR channel, the FL channel, the C channel, the SR channel, and the SL channel). For each channel, the audio reproduction unit 105 outputs the audio reproduction signal of the channel in the form of audio via the reproduction speaker connection unit 101 from one of the reproduction speakers 2 that corresponds to the channel.

The opposite-phase signal generation unit 106 generates, for each channel, an opposite-phase signal of the audio reproduction signal reproduced by the audio reproduction unit 105.

The installation position information storage unit 107 stores, for each of the reproduction speakers 2, installation position information (an attenuation rate and a delay time of an audio signal output in the form of audio from the reproduction speaker 2, at the installation position of the opposite-phase speaker 3).

The test signal output unit 108 outputs the test signal via the reproduction speaker connection unit 101 in accordance with a test request received by the request reception unit 103 from the wireless terminal 4, from one of the reproduction speakers 2 that corresponds to a channel specified in this test request.

The measurement result reception unit 109 receives, from the wireless terminal 4 via the wireless network interface unit 100, measurement results of the test signals output in the form of audio from the respective reproduction speakers 2 which include volume levels and arrival timing at the installation position of the opposite-phase speaker 3.

The installation position information calculation unit 110 calculates installation position information for each of the reproduction speakers 2 based on the output volume level and the output timing of the test signal output from the reproduction speaker 2, and on the volume level and the arrival timing of the test signal at the installation position of the opposite-phase speaker 3 that are included in a measurement result received by the measurement result reception unit 109. Specifically, for each of the reproduction speakers 2, the attenuation rate of the test signal at the installation position of the opposite-phase speaker 3 is calculated based on a ratio of the output volume level of the test signal to the volume level (measurement result) of the test signal at the installation position of the opposite-phase speaker 3. The delay time of the test signal at the installation position of the opposite-phase speaker 3 is also calculated for each of the reproduction speakers 2 based on a difference between the output timing of the test signal and the arrival timing (measurement result) of the test signal at the installation position of the opposite-phase speaker 3. The installation position information calculation unit 110 also stores, for each of the reproduction speakers 2, the calculated attenuation rate and delay time of the test signal as the installation position information in the installation position information storage unit 107, in association with the corresponding one of the reproduction speakers 2.

The opposite-phase signal output unit 111 adjusts, for each of the reproduction speakers 2, an output volume level and output timing of an opposite-phase signal that is generated by the opposite-phase signal generation unit 106 and that is output from a channel corresponding to the reproduction speaker 2, based on a piece of installation position information that is stored in the installation position information storage unit 107 in association with the reproduction speaker 2. Specifically, for each of the reproduction speakers 2, an opposite-phase signal of a channel corresponding to the reproduction speaker 2 is attenuated at an attenuation ratio included in a piece of installation position information that is stored in the installation position information storage unit 107 in association with the reproduction speaker 2, and is also delayed by a delay time included in the piece of installation position information that is stored in the installation position information storage unit 107 in association with the reproduction speaker 2. The opposite-phase signal output unit 111 also synthesizes opposite-phase signals of all channels that have been adjusted in output volume level and output timing into a synthesized opposite-phase signal, and outputs this synthesized opposite-phase signal from the opposite-phase speaker 3 via the opposite-phase speaker connection unit 102.

The main control unit 112 centrally controls the units 100 to 111 of the multi-channel audio device 1.

The functional configuration of the multi-channel audio device 1 illustrated in FIG. 4 may be implemented by hardware with use of an integrated logic IC, such as an application specific integrated circuit (ASIC) or a field programmable gate array (FPGA), or may be implemented by software with use of a computer such as a digital signal processor (DSP). As another example, the functional configuration may be implemented as a process on a general computer, such as a personal computer (PC), including a central processing unit (CPU), a memory, a flash memory, a hard disk drive, or another auxiliary storage device, and a wireless communication device which is a wireless LAN adapter or the like, by the CPU by loading a predetermined program into the memory from the auxiliary storage device and executing the program.

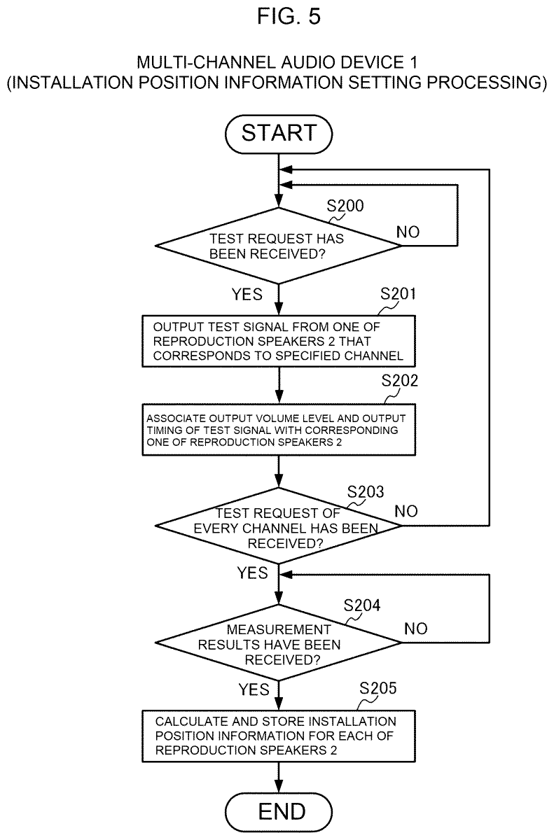

FIG. 5 is a flow chart for illustrating installation position information setting processing of the multi-channel audio device 1.

The request reception unit 103 receives a test request via the wireless network interface unit 100 from the wireless terminal 4 (“YES” in Step S200), and outputs this test request to the main control unit 112. The main control unit 112 receives the test request and instructs the test signal output unit 108 to output the test signal to one of the reproduction speakers 2 that corresponds to a channel specified in the test request. The test signal output unit 108 transmits the test signal via the reproduction speaker connection unit 101 to the one of the reproduction speakers 2 that is instructed by the main control unit 112, and outputs the test signal in the form of audio from the reproduction speaker 2 (Step S201).

The test signal output unit 108 also notifies the output volume level and the output timing of the test signal that is output from the reproduction speaker 2 to the main control unit 112. The main control unit 112 receives the notification and stores the output volume level and the output timing notified from the test signal output unit 108 in association with the reproduction speaker 2 that corresponds to the channel specified in the test request (Step S202).

Next, the main control unit 112 determines whether a test request accompanied by specification of a corresponding channel has been received for every one of the reproduction speakers 2 connected to the reproduction speaker connection unit 101 (Step S203). When there has been no reception of a test request accompanied by specification of a corresponding channel for some of the reproduction speakers 2 (“NO” in Step S203), the process returns to Step S200. When a test request accompanied by specification of a corresponding channel has been received for every one of the reproduction speakers 2 (“YES” in Step S203), the process proceeds to Step S204.

In Step S204, the measurement result reception unit 109 receives, via the wireless network interface unit 100 from the wireless terminal 4, measurement results (the volume levels and the arrival timing of the test signals of the respective channels at the installation position of the opposite-phase speaker 3) about the test signals output in the form of audio from the respective reproduction speakers 2 (“YES” in Step S204), and outputs those measurement results to the main control unit 112.

The main control unit 112 receives the measurement results, notifies the measurement results about the test signals output in the form of audio from the respective reproduction speakers 2 to the installation position information calculation unit 110, together with the output volume levels and the output timing that are stored in association with the respective reproduction speakers 2, and gives an instruction to calculate installation position information of each of the reproduction speakers 2. The installation position information calculation unit 110 receives the instruction and calculates installation position information of each of the reproduction speakers 2. Specifically, for each of the reproduction speakers 2, the attenuation rate of the test signal at the installation position of the opposite-phase speaker 3 is calculated based on a ratio of the output volume level of the test signal to the volume level (measurement result) of the test signal at the installation position of the opposite-phase speaker 3. The delay time of the test signal at the installation position of the opposite-phase speaker 3 is also calculated for each of the reproduction speakers 2 based on a difference between the output timing of the test signal and the arrival timing (measurement result) of the test signal at the installation position of the opposite-phase speaker 3. The installation position information calculation unit 110 then stores, for each of the reproduction speakers 2, the calculated attenuation rate and delay time of the test signal as the installation position information in the installation position information storage unit 107, in association with the corresponding one of the reproduction speakers 2 (Step S205).

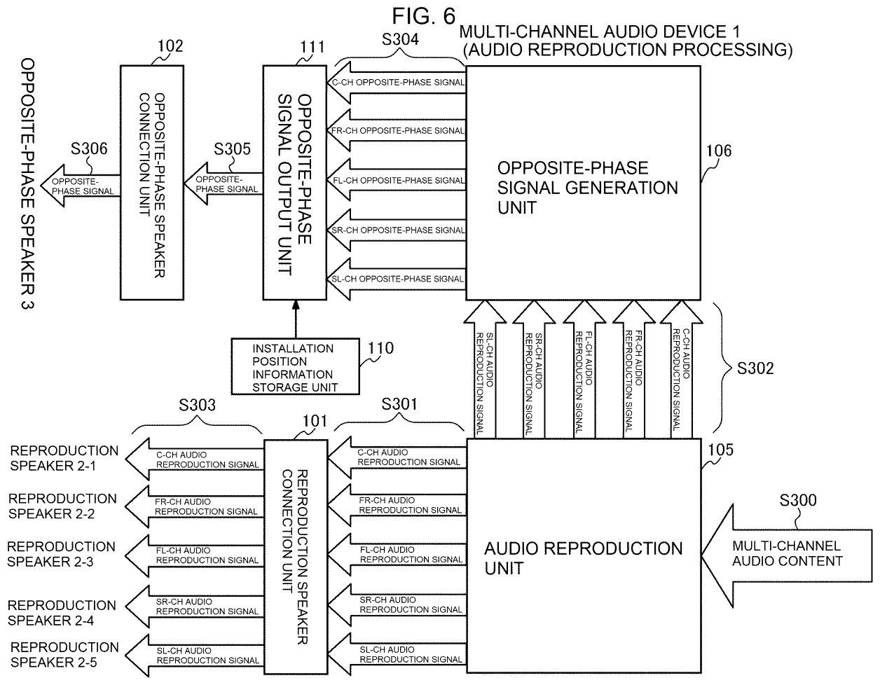

FIG. 6 is a diagram for illustrating a flow of signals in audio reproduction processing of the multi-channel audio device 1, and utilizes a part of the functional configuration diagram illustrated in FIG. 4.

First, the main control unit 112 fulfills an audio reproduction request received via the request reception unit 103 from the wireless terminal 4, by outputting, to the audio reproduction unit 105, multi-channel audio content that is downloaded by the tune acquisition unit 104 from the media server 5 and that is specified in this audio reproduction request (Step S300).

Next, the audio reproduction unit 105 reproduces the multi-channel audio content input from the main control unit 112, in the form of audio reproduction signals of a plurality of channels (in this embodiment, the FR channel, the FL channel, the C channel, the SR channel, and the SL channel). The audio reproduction signals of the plurality of channels are output to the reproduction speaker connection unit 101 and the opposite-phase signal generation unit 106 (Step S301 and Step S302).

Next, the reproduction speaker connection unit 101 outputs the audio reproduction signal of each of the plurality of channels which has been input from the audio reproduction unit 105, to one of the reproduction speakers 2 that corresponds to the channel (Step S303), and outputs the audio reproduction signal in the form of audio from the one of the reproduction speakers 2.

Meanwhile, the opposite-phase signal generation unit 106 generates an opposite-phase signal for the audio reproduction signal of each of the plurality of channels which has been input from the audio reproduction unit 105, and outputs the opposite-phase signal to the opposite-phase signal output unit 111 (Step S304). The opposite-phase signal output unit 111 receives the opposite-phase signal, and adjusts the output volume level and the output timing of the opposite-phase signal input from the opposite-phase signal generation unit 106, in accordance with a piece of installation position information that is stored in the installation position information storage unit 107 in association with one of the reproduction speakers 2 that corresponds to the channel of the opposite-phase signal. Specifically, for each of the reproduction speakers 2, the opposite-phase signal of a channel corresponding to the reproduction speaker 2 is attenuated at an attenuation ratio included in a piece of installation position information that is associated with the reproduction speaker 2, and is also delayed by a delay time included in this piece of installation position information. The opposite-phase signal output unit 111 then synthesizes opposite-phase signals of all channels that have been adjusted in output volume level and output timing into a synthesized opposite-phase signal, and outputs this synthesized opposite-phase signal to the opposite-phase speaker connection unit 102 (Step S305).

The opposite-phase speaker connection unit 102 receives the synthesized opposite-phase signal, and outputs the synthesized opposite-phase signal to the opposite-phase speaker 3 (Step S306) to output the synthesized opposite-phase signal from the opposite-phase speaker 3 in the form of audio.

Details of the wireless terminal 4 are described next.

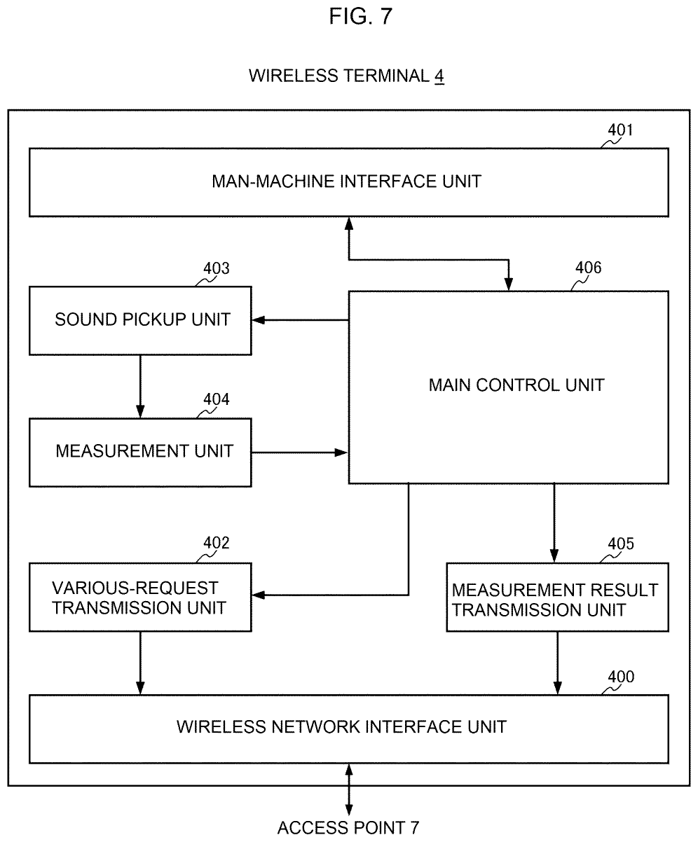

FIG. 7 is a schematic functional configuration diagram of the wireless terminal 4.

As illustrated, the wireless terminal 4 includes a wireless network interface unit 400, a man-machine interface unit 401, a various-request transmission unit 402, a sound pickup unit 403, a measurement unit 404, a measurement result transmission unit 405, and a main control unit 406.

The wireless network interface unit 400 is an interface for wireless connection to the access point 7.

The man-machine interface unit 401 is an interface for displaying information to the user and for receiving various types of operation from the user, and includes an input/output device such as a touch panel.

The various-request transmission unit 402 transmits various requests such as a test request accompanied by the specification of a channel and an audio reproduction request accompanied by the specification of a tune title to the multi-channel audio device 1 via the wireless network interface unit 400, by following various types of operation received from the user via the man-machine interface unit 401.

In a case in which the various-request transmission unit 402 transmits a test request to the multi-channel audio device 1, the sound pickup unit 403 picks up the test signal output in the form of audio from one of the reproduction speakers 2 that corresponds to a channel specified by this test request, with use of a built-in microphone of its own wireless terminal 4 or a microphone connected to the microphone input terminal.

The measurement unit 404 measures the volume level and the arrival timing of the test signal picked up by the sound pickup unit 403.

The measurement result transmission unit 405 transmits results of measurement measured by the measurement unit 404, to the multi-channel audio device 1 via the wireless network interface unit 400.

The main control unit 406 centrally controls the units 400 to 405 of the wireless terminal 4.

The functional configuration of the wireless terminal 4 that is illustrated in FIG. 7 is implemented on a portable computer including a CPU, a memory, a flash memory or another auxiliary storage device, a wireless communication device which is a wireless LAN adapter or the like, a microphone, and a speaker, such as a smartphone or a tablet PC, by the CPU by executing a predetermined program.

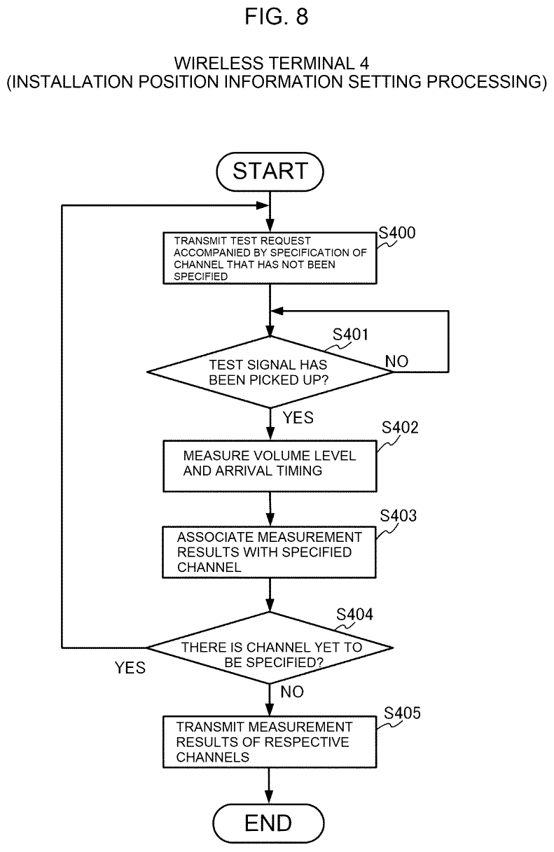

FIG. 8 is a flow chart for illustrating installation position information setting processing of the wireless terminal 4.

This flow is started by reception of installation position information setting operation from the user by the man-machine interface unit 401.

First, the main control unit 406 notifies, to the various-request transmission unit 402, a channel that has not been specified out of the plurality of channels to which the plurality of reproduction speakers 2 connected to the multi-channel audio device 1 correspond, and instructs the various-request transmission unit 402 to transmit a test request. The various-request transmission unit 402 receives the instruction and transmits a test request accompanied by the specification of the channel notified from the main control unit 406, to the multi-channel audio device 1 via the wireless network interface unit 400 (Step S400).

The test signal is then output in the form of audio from one of the reproduction speakers 2 that corresponds to the channel specified by this test request, and is picked up by the sound pickup unit 403 (“YES” in Step S401). The measurement unit 404 measures the volume level and the arrival timing of the test signal picked up by the sound pickup unit 403 (Step S402). The measurement unit 404 notifies those measurement results (the volume level and the arrival timing) to the main control unit 406. The main control unit 406 receives the notification and stores the measurement results notified by the measurement unit 404, in association with the channel specified by the test request transmitted in Step S400 (Step S403).

Next, the main control unit 406 determines whether there is a channel that has not been specified in test requests transmitted by the various-request transmission unit 402, among the plurality of channels to which the plurality of reproduction speakers 2 connected to the multi-channel audio device 1 correspond (Step S404). When there is a channel yet to be specified (“YES” in Step S404), the process returns to Step S400. When every one of the plurality of channels has been specified and there is no channel yet to be specified (“NO” in Step S404), on the other hand, the main control unit 406 notifies the respective measurement results about the test signals of the plurality of channels to the measurement result transmission unit 405. The measurement result transmission unit 405 receives the notification and transmits, to the multi-channel audio device 1 via the wireless network interface unit 400, the respective measurement results about the test signals of the channels to which the plurality of reproduction speakers 2 connected to the multi-channel audio device 1 correspond (Step S405).

This concludes the description of the one embodiment of the present invention.

In this embodiment, for each of the reproduction speakers 2, an attenuation rate and a delay time of a test signal output in the form of audio from the reproduction speaker 2 that are observed at the installation position of the opposite-phase speaker 3 are stored in advance as a piece of installation position information of the reproduction speaker 2. Then, at a time of reproduction of the multi-channel audio content, for each of the reproduction speakers 2, an opposite-phase signal of an audio reproduction signal output in the form of audio from the reproduction speaker 2 is attenuated based on the attenuation rate included in the piece of installation position information of the reproduction speaker 2, and is delayed based on the delay time included in the piece of installation position information of the reproduction speaker 2. Subsequently, opposite-phase signals adjusted in volume level and output timing are synthesized into a synthesized opposite-phase signal, and the synthesized opposite-phase signal is output in the form of audio from the opposite-phase speaker 3. Accordingly, audio reproduction signals output in the form of audio from the respective reproduction speakers 2 can be canceled out at the installation position of the opposite-phase speaker 3.

Thus, according to this embodiment, even when the user listens to multi-channel audio at a volume level preferred by the user in a room in which the multi-channel audio system is installed, sound leakage outside the room can be suppressed by installing the opposite-phase speaker 3 at a location (for example, the vicinity of a window, a wall, or a door) at which sound leakage from the room to the outside is suspected to occur.

In this embodiment, in the installation position information setting processing, the wireless terminal 4 uses a built-in microphone or an external microphone placed at the installation position of the opposite-phase speaker 3 to pick up, for each of the reproduction speakers 2, an audio reproduction signal output in the form of audio from the reproduction speaker 2, and associates results of measuring the volume level and the arrival timing of the picked up signal with a channel that corresponds to the reproduction speaker 2. The wireless terminal 4 then transmits the measurement results about test signals of the respective channels to the multi-channel audio device 1. The multi-channel audio device 1 receives the measurement results, and calculates, for each of the reproduction speakers 2, a piece of installation position information of the reproduction speaker 2 based on the output volume level and the output timing at which an audio reproduction signal is output from the reproduction speaker 2, and on the measurement results received from the wireless terminal 4 about the test signal of the channel that corresponds to the reproduction speaker 2.

Thus, according to this embodiment, even in a case in which the installation position of the reproduction speakers 2-1 to 2-5 or the opposite-phase speaker 3 is changed, sound leakage outside a room in which the user is listening to multi-channel audio at a volume level preferred by the user can be suppressed by executing the installation position information setting processing again to re-calculate the pieces of installation position information of the respective reproduction speakers 2.

The present invention is not limited to the embodiment described above, and various changes may be made thereto within the scope of the gist of the present invention.

For example, in the embodiment described above, the opposite-phase speaker 3 may be a wireless speaker wirelessly connected to the multi-channel audio device 1 through the wireless network interface unit 100 via the access point 7. Alternatively, the opposite-phase speaker 3 may be a wireless speaker connected directly to the multi-channel audio device 1 by wireless connection through short-range wireless communication such as Bluetooth (trademark). In this case, the delay time included in the installation position information of each of the reproduction speakers 2 is preferred to be corrected so as to be shorter by a transmission time of an audio signal transmitted from the multi-channel audio device 1 to the opposite-phase speaker 3.

In the embodiment described above, the sound pickup unit 403 and the measurement unit 404 included in the wireless terminal 4 may be built in the multi-channel audio device 1, and an external microphone may be connected to the multi-channel audio device 1. In this case, when receiving a test request from the wireless terminal 4, the multi-channel audio device 1 outputs a test signal in the form of audio from one of the reproduction speakers 2 that corresponds to a channel specified by this test request, picks up the test signal with use of the external microphone placed at the installation position of the opposite-phase speaker 3 and the sound pickup unit 403 built in the multi-channel audio device 1, and measures the volume level and the arrival timing of the test signal with the measurement unit 404 built in the multi-channel audio device 1. Once the volume level and the arrival timing of the test signal are measured for every one of the reproduction speakers 2, those measurement results are handed over to the main control unit 112. Step S205 of FIG. 5 is then executed to have the installation position information calculation unit 110 calculate the installation position information of each of the reproduction speakers 2.

In this case, the sound pickup unit 403, the measurement unit 404, and the measurement result transmission unit 405 can be omitted from the wireless terminal 4. In addition, the measurement result reception unit 109 can be omitted from the multi-channel audio device 1. Further, when the opposite-phase speaker 3 is a wireless speaker in this case, the microphone may be built in the opposite-phase speaker 3.

In the embodiment described above, a low-pass filter may be built in the opposite-phase signal output unit 111 of the multi-channel audio device 1 to cut a high-frequency component of an opposite-phase signal output from the opposite-phase signal output unit 111 to the opposite-phase speaker connection unit 102. In this way, an effect of the opposite-phase signal over a listening environment in the room can be reduced by outputting only low-frequency components which are liable to leak outside the room from the opposite-phase speaker 3 in the form of audio.

Further, in the embodiment described above, the communication between the multi-channel audio device 1 and the wireless terminal 4 is performed via the access point 7, but the present invention is not limited thereto. Wireless communication may be performed directly between the multi-channel audio device 1 and the wireless terminal 4 by short-range wireless communication such as Bluetooth (trademark).

In the embodiment described above, the description takes, as an example, a multi-channel audio system in which the multi-channel audio device 1 reproduces multi-channel audio content downloaded from the media server 5 in the form of audio reproduction signals for the respective channels, and outputs the audio reproduction signals from the reproduction speakers 2-1 to 2-5 in the form of audio. However, the present invention is not limited thereto. The present invention is applicable to a wide range of audio systems that include an audio device which outputs an audio reproduction signal and a reproduction speaker which outputs, in the form of audio, the audio reproduction signal output from the audio device.

### REFERENCE SIGNS LIST

1: multi-channel audio device
2-1 to 2-5: reproduction speaker
3: opposite-phase speaker 4: wireless terminal
5: media server 6: network
7: access point
100, 400: wireless network interface unit
101: reproduction speaker connection unit 102: opposite-phase speaker connection unit
103: request reception unit 104: tune acquisition unit
105: audio reproduction unit 106: opposite-phase signal generation unit
107: installation position information storage unit 108: test signal output unit
109: measurement result reception unit 110: installation position information calculation unit
111: opposite-phase signal output unit 112, 406: main control unit
401: man-machine interface unit
402: various-request transmission unit 403: sound pickup unit
404: measurement unit 405: measurement result transmission unit

1. An audio system, comprising:
an audio device configured to output an audio reproduction signal; and
a reproduction speaker configured to output, in the form of audio, the audio reproduction signal output from the audio device,
wherein the audio system further comprises an opposite-phase speaker,
wherein the audio device includes:
opposite-phase signal generation means for generating an opposite-phase signal of the audio reproduction signal;
installation position information storage means for storing an attenuation rate and a delay time of the audio reproduction signal output in the form of audio from the reproduction speaker that are observed at an installation position of the opposite-phase speaker; and
opposite-phase signal output means for outputting the opposite-phase signal generated by the opposite-phase signal generation means to the opposite-phase speaker, with the opposite-phase signal attenuated based on the attenuation rate stored in the installation position information storage means, and delayed based on the delay time stored in the installation position information storage means, and
wherein the opposite-phase speaker is configured to output, in the form of audio, the opposite-phase signal output from the audio device.

2. The audio system according to claim 1, further comprising a wireless terminal configured to remotely operate the audio device,
wherein the wireless terminal includes:
a built-in or external microphone;
measurement means for picking up, with the built-in or external microphone, the audio reproduction signal output in the form of audio from the reproduction speaker, and for measuring a volume level and arrival timing of the audio reproduction signal at the installation position of the opposite-phase speaker; and
measurement result transmission means for transmitting results of the measurement by the measurement means to the audio device, and
wherein the audio device further includes calculation means for calculating the attenuation rate and the delay time of the audio reproduction signal at the installation position of the opposite-phase speaker based on an output volume level and output timing at which the audio reproduction signal is output from the reproduction speaker, and on the results of the measurement received from the wireless terminal, and for storing the calculated attenuation ratio and delay time in the installation position information storage means.

3. The audio system according to claim 1, further comprising a microphone connected to the audio device,
wherein the audio device further includes:
measurement means for picking up, with the microphone, the audio reproduction signal output in the form of audio from the reproduction speaker, and for measuring a volume level and arrival timing of the audio reproduction signal at the installation position of the opposite-phase speaker; and
calculation means for calculating the attenuation rate and the delay time of the audio reproduction signal at the installation position of the opposite-phase speaker based on an output volume level and output timing at which the audio reproduction signal is output from the reproduction speaker, and on results of the measurement by the measurement means, and for storing the calculated attenuation ratio and delay time in the installation position information storage means.

4. The audio system according to claim 3,
wherein the opposite phase speaker is a wireless speaker, and
wherein the microphone is built in the opposite-phase speaker.

5. The audio system according to claim 1, wherein the opposite-phase signal output means includes a low-pass filter configured to cut a high-frequency component of the opposite-phase signal output to the opposite-phase speaker.

6. The audio system according to claim 1,
wherein the audio device is configured to reproduce multi-channel audio and output the audio reproduction signal for each of channels,
wherein the reproduction speaker is provided for each of the channels,
wherein the opposite-phase signal generation means is configured to generate an opposite-phase signal of the audio reproduction signal for each of the channels,
wherein the installation position information storage means is configured to store, for each reproduction speaker, the attenuation rate and the delay time of the audio reproduction signal output in the form of audio from the each reproduction speaker that are observed at the installation position of the opposite-phase speaker, and
wherein the opposite-phase signal output means is configured to:
attenuate, for each reproduction speaker, the opposite-phase signal generated by the opposite-phase signal generation means with respect to one of the channels that corresponds to the each reproduction speaker, based on the attenuation rate stored in the installation position information storage means in association with the each reproduction speaker, and delay the opposite-phase signal based on the delay time stored in the installation position information storage means in association with the each reproduction speaker;
synthesize opposite-phase signals of the respective channels into a synthesized opposite-phase signal; and
output the synthesized opposite-phase signal.

7. The audio system according to claim 5,
wherein the audio device is configured to reproduce multi-channel audio and output the audio reproduction signal for each of channels,
wherein the reproduction speaker is provided for each of the channels,
wherein the opposite-phase signal generation means is configured to generate an opposite-phase signal of the audio reproduction signal for each of the channels,
wherein the installation position information storage means is configured to store, for each reproduction speaker, the attenuation rate and the delay time of the audio reproduction signal output in the form of audio from the each reproduction speaker that are observed at the installation position of the opposite-phase speaker, and
wherein the opposite-phase signal output means is configured to:
attenuate, for each reproduction speaker, the opposite-phase signal generated by the opposite-phase signal generation means with respect to one of the channels that corresponds to the each reproduction speaker, based on the attenuation rate stored in the installation position information storage means in association with the each reproduction speaker, and delay the opposite-phase signal based on the delay time stored in the installation position information storage means in association with the each reproduction speaker;
synthesize opposite-phase signals of the respective channels into a synthesized opposite-phase signal; and
output the synthesized opposite-phase signal.

8. An audio device for outputting an audio reproduction signal to a reproduction speaker, comprising:
opposite-phase signal generation means for generating an opposite-phase signal of the audio reproduction signal;
installation position information storage means for storing an attenuation rate and a delay time of the audio reproduction signal output in the form of audio from the reproduction speaker that are observed at an installation position of an opposite-phase speaker provided separately from the reproduction speaker; and
opposite-phase signal output means for outputting the opposite-phase signal generated by the opposite-phase signal generation means to the opposite-phase speaker, with the opposite-phase signal attenuated based on the attenuation rate stored in the installation position information storage means, and delayed based on the delay time stored in the installation position information storage means.

9. The audio device according to claim 8, further comprising:
measurement means for measuring a volume level and arrival timing of the audio reproduction signal output in the form of audio from the reproduction speaker at the installation position of the opposite-phase speaker; and
calculation means for calculating the attenuation rate and the delay time of the audio reproduction signal at the installation position of the opposite-phase speaker based on a volume level and output timing at which the audio reproduction signal is output from the reproduction speaker, and on results of the measurement by the measurement means, and for storing the calculated attenuation ratio and delay time in the installation position information storage means.

10. The audio device according to claim 8, wherein the opposite-phase signal output means includes a low-pass filter configured to cut a high-frequency component of the opposite-phase signal output to the opposite-phase speaker.

11. The audio device according to claim 8,
wherein the audio device is configured to reproduce multi-channel audio and output, for each of channels, the audio reproduction signal from the reproduction speaker that corresponds to the each of the channels,
wherein the opposite-phase signal generation means is configured to generate an opposite-phase signal of the audio reproduction signal for each of the channels,
wherein the installation position information storage means is configured to store, for each reproduction speaker, the attenuation rate and the delay time of the audio reproduction signal output in the form of audio from the each reproduction speaker that are observed at the installation position of the opposite-phase speaker, and
wherein the opposite-phase signal output means is configured to:
attenuate, for each reproduction speaker, the opposite-phase signal generated by the opposite-phase signal generation means with respect to one of the channels that corresponds to the each reproduction speaker, based on the attenuation rate stored in the installation position information storage means in association with the each reproduction speaker, and delay the opposite-phase signal based on the delay time stored in the installation position information storage means in association with the each reproduction speaker;
synthesize opposite-phase signals of the respective channels into a synthesized opposite-phase signal; and
output the synthesized opposite-phase signal.

12. The audio device according to claim 10,
wherein the audio device is configured to reproduce multi-channel audio and output, for each of channels, the audio reproduction signal from the reproduction speaker that corresponds to the each of the channels,
wherein the opposite-phase signal generation means is configured to generate an opposite-phase signal of the audio reproduction signal for each of the channels,
wherein the installation position information storage means is configured to store, for each reproduction speaker, the attenuation rate and the delay time of the audio reproduction signal output in the form of audio from the each reproduction speaker that are observed at the installation position of the opposite-phase speaker, and
wherein the opposite-phase signal output means is configured to:
attenuate, for each reproduction speaker, the opposite-phase signal generated by the opposite-phase signal generation means with respect to one of the channels that corresponds to the each reproduction speaker, based on the attenuation rate stored in the installation position information storage means in association with the each reproduction speaker, and delay the opposite-phase signal based on the delay time stored in the installation position information storage means in association with the each reproduction speaker;
synthesize opposite-phase signals of the respective channels into a synthesized opposite-phase signal; and
output the synthesized opposite-phase signal.

13. A program for causing a computer to function as an audio device for outputting an audio reproduction signal to a reproduction speaker, the program causing the computer to function as:
opposite-phase signal generation means for generating an opposite-phase signal of the audio reproduction signal;
installation position information storage means for storing an attenuation rate and a delay time of the audio reproduction signal output in the form of audio from the reproduction speaker that are observed at an installation position of an opposite-phase speaker provided separately from the reproduction speaker; and
opposite-phase signal output means for outputting the opposite-phase signal generated by the opposite-phase signal generation means to the opposite-phase speaker, with the opposite-phase signal attenuated based on the attenuation rate stored in the installation position information storage means, and delayed based on the delay time stored in the installation position information storage means.

14. An audio reproduction method for reproducing audio by an audio system including an audio device configured to output an audio reproduction signal and a reproduction speaker configured to output, in the form of audio, the audio reproduction signal output from the audio device, the audio reproduction method comprising:
installing an opposite-phase speaker;
generating, by the audio device, an opposite-phase signal of the audio reproduction signal;
outputting, by the audio device, the opposite-phase signal attenuated and delayed based on an attenuation rate and a delay time that are stored in advance, the stored attenuation rate and delay time being an attenuation rate and a delay time of the audio reproduction signal output in the form of audio from the reproduction speaker that are observed at an installation position of the opposite-phase speaker; and
outputting, by the opposite-phase speaker, in the form of audio, the opposite-phase signal output from the audio device.
